(19) United States
(12) Patent Application Publication
(10) Pub. No.: US 2008/0130565 A1
(43) Pub. Date: Jun. 5, 2008

(54) METHOD OF PERFORMING MEDIUM ACCESS CONTROL (MAC) AND ALLOCATING RESOURCES TO NODES IN WIRELESS AD HOC NETWORK, AND COMPUTER-READABLE RECORDING MEDIUM STORING FRAME STRUCTURE FOR EXECUTING THE METHOD

(75) Inventors: Wun-Cheol Jeong, Cheongju-city (KR); Jong-Moon Chung, Seoul (KR); Hyung-Weon Cho, Seoul (KR); Ki-Yong Jin, Seoul (KR); Nae-Soo Kim, Daejeon-city (KR); Cheol-Sig Pyo, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Electronics and Telecommunications Research Institute, Daejeon-city (KR); Yonsei University Industry-Academic Cooperation Foundation, Seoul (KR)

(21) Appl. No.: 11/932,942

(22) Filed: Oct. 31, 2007

(30) Foreign Application Priority Data
Dec. 5, 2006 (KR) 10-2006-0122621
Mar. 20, 2007 (KR) 10-2007-0027292

(51) Int. Cl. H04Q 7/00

(52) U.S. Cl. 370/329

(57) ABSTRACT

Provided is a recording medium for storing a structure of a frame for performing Medium Access Control (MAC) and allocating resources in a multi-hop wireless Ad hoc network, and a method of performing Medium Access Control (MAC) and allocating resources in a multi-hop wireless Ad Hoc network. The method includes performing initialization of communication by receiving or transmitting a Request-To-Send (RTS) message and a Clear-To-Send (CTS) message from or to a node that is to be communicated with in the multi-hop wireless Ad hoc network; constructing a frame comprising at least one slot comprising an initialization field for performing the initialization of communication, a high level link region for communication between Full Function Device (FFD) nodes in the multi-hop wireless Ad hoc network which exist within a one-hop distance in the multi-hop wireless Ad hoc network, and a low level link region for communication between Reduced Function Device (RFD) nodes in the multi-hop wireless Ad hoc network which exist within a one-hop distance from the reference FFD node; allocating the resources to the frame on the basis of data types, priorities, and estimated interference values; and performing communication between nodes in the multi-hop wireless Ad hoc network within the length of the frame, and then returning to the operation of performing initialization of communication. Therefore, by effectively executing MAC and allocating resources according to a variety of data requests, it is possible to improve the reliability and Quality of Service (QoS) of the multi-hop wireless Ad hoc network and reduce power consumption.

### CROSS-REFERENCE TO RELATED PATENT APPLICATION

This application claims the benefit of Korean Patent Application No. 10-2006-0122621, filed on Dec. 5, 2006 and Korean Patent Application No. 10-2007-0027292, filed on Mar. 20, 2007 in the Korean Intellectual Property Office, the disclosures of which are incorporated herein in their entirety by reference.

### BACKGROUND OF THE INVENTION

1. Field of the Invention

The present invention relates to Medium Access Control (MAC) and resource allocation for supporting communications between nodes constituting a wireless Ad hoc network, and a recording medium storing a frame structure used for the MAC and resource allocation, and more particularly, to a MAC and resource allocation method for efficiently performing MAC and allocating resources to nodes in consideration of priorities, data types, interference generated by multi-hop in a wireless Ad hoc network, etc., thereby improving the performance of the wireless Ad hoc network and reducing power consumption to improve the life time of the wireless Ad hoc network, and a recording medium storing a frame structure used for the MAC and resource allocation method.

This work was supported by the IT R&D program of MIC/IITA[2005-S-106-02, Development of Sensor Tag and Sensor Node Technologies for RFID/USN].

2. Description of the Related Art

A method for performing Medium Access Control (MAC) which is generally applied to a wireless Ad hoc network is a Carrier Sensing Multiple Access/Collision Avoidance (CSMA/CA) method. In the CSMA/CA method, while nodes that try to transmit data monitor the state of a channel, the nodes perform initialization of communication if the channel is converted into an idle state (that is, a state in which no node transmits data). Some of the nodes that try to transmit data transmit Request-To-Send (RTS) messages, and wait to receive Clear-To-Send (CTS) messages. At this time, if the RTS messages are simultaneously transmitted, the RTS messages collide with each other, and nodes which do not receive any CTS message again try to transmit RTS messages after waiting for a backoff time period.

FIG. 1 is a view for explaining a conventional method for performing CSMA/CA-based MAC.

Initialization of communication by nodes that want to transmit data is performed in an RTS/CTS window period 101, and nodes which have received CTS messages communicate with the corresponding nodes through a slot 102. If the communication is complete, the communication channel is again converted into an idle state, and initialization of communication by exchanging RTS messages and CTS messages with each other is again repeated in RTS/CTS window periods 103 and 105, and then only nodes which have received the CTS messages are allocated to slots 104 and 106 so that the nodes can communicate with the corresponding nodes.

Also, the above-described method for performing conventional CSMA/CA-based MAC can be used to allocate resources to nodes which are first connected to the wireless Ad hoc network, regardless of data types, priorities, interference generated in a multi-hop environment, etc.

FIG. 2 illustrates a wireless Ad hoc network configuration for explaining a conventional resource allocation method. Referring to FIG. 2, the wireless Ad hoc network configuration includes Full Function Device (FFD) nodes 201 and Reduced Function Device (RFD) nodes 202. The wireless Ad hoc network is constructed through communication between the FFD nodes 201 and the RFD nodes 202 and multi-hop relay between the FFD nodes 201. Since the multi-hop is generated in all the FFD nodes 201 constituting the wireless Ad hoc network, the multi-hop causes an interference 203 in neighboring nodes of the wireless Ad hoc network. The conventional method for performing CSMA/CA-based MAC is used to allocate resources to nodes, without considering such interference 203 generated by the multi-hop.

In the conventional method for performing CSMA/CA-based MAC, since initialization of communication is performed whenever a slot is used as a communication slot and even on nodes that are constantly used, unnecessary resources are consumed and power consumption increases, thus reducing the lifetime of the wireless Ad hoc network. Also, an idle state for minimizing collision acts as a main cause of resource waste.

Since resources are allocated to nodes in the conventional method for performing CSMA/CA-based MAC, regardless of data types such as urgent data and general state notification data, data priorities, etc., retransmission is frequent, and an appropriate Quality of Service (QoS) cannot be provided. Also, since the conventional method for performing CSMA/CA-based MAC does not consider interference by multi-hop as well as interference of the wireless Ad hoc network, the performance of the wireless Ad hoc network is reduced.

### SUMMARY OF THE INVENTION

The present invention provides a dynamic resource allocation method for efficiently performing Medium Access Control (MAC) and dynamically allocating a limited amount of resources to nodes according to a network situation, in a wireless Ad hoc network in which the resources exist, a variety of data types are provided, multi-hop relay exists, and low power is required, thereby improving the Quality of Service (QoS), performance, and life time of the wireless Ad hoc network.

The present invention also provides a recording medium storing a frame structure for performing the Medium Access Control (MAC) and allocating resources in the multi-hop wireless Ad hoc network.

According to an aspect of the present invention, there is provided a recording medium storing a structure of a frame for performing Medium Access Control (MAC) and allocating resources in a multi-hop wireless Ad hoc network, the structure of a frame including an initialization field performing initialization of communication between nodes constituting the multi-hop wireless Ad hoc network; and at least one slot comprising a high level link region for communication between Full Function Device (FFD) nodes existing within a one-hop distance from a reference FFD node, and a low level link region for communication between Reduced Function Device (RFD) nodes existing within a one-hop distance from the reference FFD node.

According to another aspect of the present invention, there is provided a method of performing Medium Access Control (MAC) and allocating resources in a multi-hop wireless Ad hoc network, the method including performing initialization of communication by receiving or transmitting a Request-To-Send (RTS) message and a Clear-To-Send (CTS) message from or to a node that is to be communicated with in the multi-hop wireless Ad hoc network; constructing a frame comprising at least one slot comprising an initialization field for performing the initialization of communication, a high level link region for communication between Full Function Device (FFD) nodes in the multi-hop wireless Ad hoc network which exist within a one-hop distance in the multi-hop wireless Ad hoc network, and a low level link region for communication between Reduced Function Device (RFD) nodes in the multi-hop wireless Ad hoc network which exist within a one-hop distance from the reference FFD node; allocating the resources to the frame on the basis of data types, priorities, and estimated interference values; and performing communication between nodes in the multi-hop wireless Ad hoc network within the length of the frame, and then returning to the operation of performing initialization of communication.

### BRIEF DESCRIPTION OF THE DRAWINGS

The above and other features and advantages of the present invention will become more apparent by describing in detail exemplary embodiments thereof with reference to the attached drawings in which:

FIG. 1 is a view for explaining a conventional method for performing Carrier Sensing Multiple Access/Collision Avoidance (CSMA/CA)-based MAC;

FIG. 2 illustrates a wireless Ad hoc network configuration for explaining a conventional resource allocation method;

FIG. 3 is a flowchart illustrating a MAC and resource allocation method according to an embodiment of the present invention;

FIG. 4 illustrates a frame structure according to an embodiment of the present invention; and

FIG. 5 illustrates a network configuration to which the MAC and resource allocation method of the present invention is applied, according to an embodiment of the present invention.

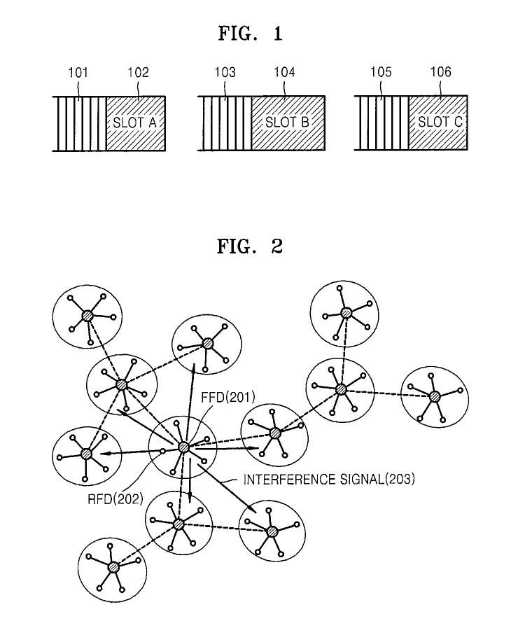

### DETAILED DESCRIPTION OF THE INVENTION

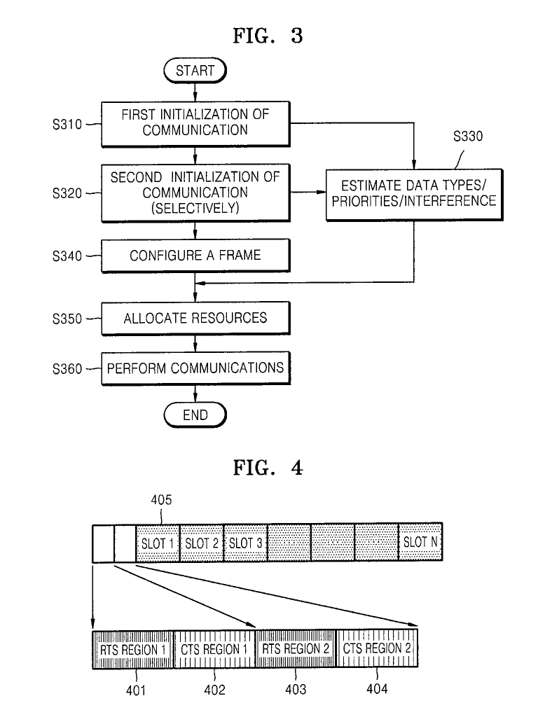

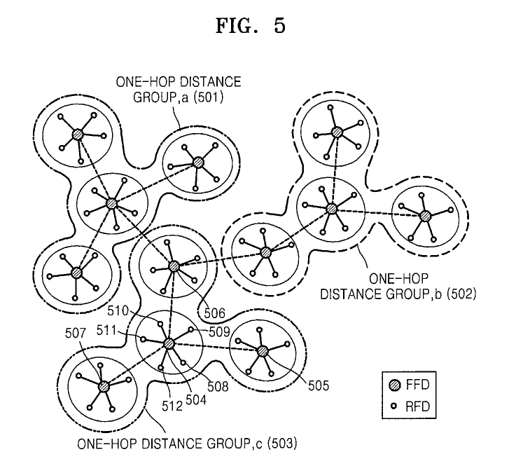

Hereinafter, embodiments of the present invention will be described in detail with reference to the appended drawings. FIG. 3 is a flowchart illustrating a MAC and resource allocation method according to an embodiment of the present invention. FIG. 4 illustrates a frame structure according to an embodiment of the present invention. FIG. 5 illustrates a network configuration to which the MAC and resource allocation method of the present invention is applied, according to an embodiment of the present invention.

Referring to FIG. 3, the MAC and resource allocation method includes: a first initialization of communication in operation S310; a second initialization of communication in operation S320; constructing a frame in operation S340; allocating resources in operation S350 to nodes; estimating a data type/priority/interference in operation S330; and performing communication in operation S360. When communications are complete, operations S310 to S360 are repeated. Here, the operation S320 of the second initialization of communication can be selectively performed according to a wireless Ad hoc network environment.

Nodes that try to perform data communications exchange Request-To-Send (RTS) messages and Clear-To-Send (CTS) messages with each other in operation S310. Unlike a conventional technique in which communications are performed by allocating a slot to a node just after a message exchange for the node is complete, slots are allocated to nodes in operation S340 of constructing a frame, after initialization of communication of a node is complete even though initialization of communication of the other party node has been complete. Also, unlike the conventional technique in which initialization of communication is performed whenever a node is generated, since the present invention performs initialization of communication once on nodes that constantly communicate with each other, resource consumption is reduced and initialization of communication of the corresponding nodes is not performed when initialization of communication is performed on a next frame, so that collision between nodes can be reduced, more opportunities of communication participation are provided to other nodes, and the performance of the wireless Ad hoc network can be improved.

In operation S320 of the second initialization of communication, initialization of communication is performed on nodes that have been excluded in operation S310 of the first initialization of communication, or on nodes that have been not approved due to collision in operation S310 of the first initialization of communication. Here, the nodes can minimize loss due to collision, by using slots in an order which is different from an order which is applied in operation 310 of the first initialization of communication. Also, operation S320 of the second initialization of communication can be selectively performed. If operation S320 of the second initialization of communication is omitted, initialization of communication is performed in an operation of performing a first initialization of communication on a next frame.

If the initialization of communication is complete, in operation S340 of constructing a frame, a frame for communication is constructed. A frame, which is proposed in the present invention, is composed of several time slots. The length of the frame is variable, but a maximum length of the frame is predetermined. The structure of the frame according to the present invention is illustrated in FIG. 4. Referring to FIGS. 4 and 5, the frame includes an RTS region1 401 and a CTS region1 402 in which a first initialization of communication is performed, an RTS region2 403 and a CTS region2 404 in which a second initialization of communication is performed, a high level link for supporting communication between FFD nodes (for example, 504 through 507) existing within each of one-hop distance groups 501 through 503, a low level link for supporting RFD nodes (for example, 508 through 512) communicating with a reference FFD node (for example, 504) within the one-hop distance group 501 through 503, and slots 405 which can be dynamically allocated to the high level link or the low level link according to the amount of generated data. The frame can effectively cope with communication between FFD nodes or between RFD nodes which are immediately and rapidly increased to allocate resources dynamically.

When operation S340 of constructing the frame is complete, operation S350 of allocating resources (that is, time slots) to nodes which have received RTS messages, is performed. In order to effectively allocate the resources to the nodes, the present invention allocates slots to nodes, beginning from a slot having a good channel state according to data types and priorities that are classified in operation S330 of predicting a data type/priority/interference, and allocates the remaining resources to the remaining nodes according to a Signal to Interference plus Noise Ratio (SINR) which is calculated on the basis of interference estimated in a multi-hop wireless Ad hoc network.

In the present invention, messages are classified into message types such as alarm messages or general state notification messages, resources having good channel states are allocated to messages requiring urgent processing, and resources are first allocated to messages having priorities in the wireless Ad hoc network, so that the QoS of the wireless Ad hoc network can be maintained. Also, by utilizing resources having good channel states to reduce loss due to retransmission, efficient resource application and low-power communication are possible. Also,allocating nodes having a high SINR value to slots in which interference exists to reduce data loss due to interference, it is possible to enhance the performance of the entire system. Here, the SINR value can be defined by Equation 1 as follows.

$$SINR = \frac{S}{I + N} , \qquad ( 1 )$$

where S represents the strength of a signal, and I and N represent the strength of interference and noise, respectively.

Also, resources can be efficiently allocated according to the amount of data, as well as according to data types, priorities, and SINR values.

After the resource allocation is complete, communications between the nodes constituting the wireless Ad hoc network are performed within a fame in operation S360. When the communications between the nodes are complete, the MAC and resource allocation method illustrated in FIG. 3 is repeatedly performed.

In summary, the present invention relates to a method for performing MAC in a wireless Ad hoc network, and in detail, a method of dynamically allocating resources to nodes in a wireless Ad hoc network, and a frame structure which is used for MAC.

The MAC method which is adapted to the wireless Ad hoc network is implemented by a series of operations including operations S310 and S320 of performing the first and second initialization of communication, operation S330 of estimating the data type/priority/interference, operation S340 of constructing the frame, and operation S350 of dynamically allocating the resources. Operation S350 of dynamically allocating the resources to nodes is performed in such a way that the performance of a multi-hop wireless Ad hoc network is maximized in consideration of information classified in the data type/priority/interference estimating operation S330 and interference generated in the multi-hop wireless Ad hoc network environment.

The multi-hop wireless Ad hoc network is composed of FFD nodes and RFD nodes. In the present invention, FFD nodes that are separated by one hop from a reference FFD node are grouped into a one-hop distance group. Then, the one-hop distance group is classified into a high level link for communication between FFD nodes in the one-hop distance group and a low level link for communication between the reference FFD node and RFD nodes connected to the reference FFD node, and resources are allocated to the high level link and the low level link. The lengths of the resources allocated to the high level link and the low level link are not fixed, and the resources are dynamically allocated to the high level and low level links according to the amount of data which is generated in each link.

In the MAC and resource allocation method according to the present invention, since initialization of communication for allocating resources to nodes is simplified, it is possible to efficiently utilize resources, reduce the probability of collision between nodes configuring a network, and provide opportunities of communication participation to more nodes. Also, by allocating resources to nodes using a scheduling algorithm of utilizing data types, priorities, and SINR values calculated in a multi-hop wireless Ad hoc network environment, it is possible to ensure reliability of main data, reduce the probability of retransmission, achieve low-power communication in the multi-hop wireless Ad hoc network, and improve the performance of the multi-hop wireless Ad hoc network.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, since the MAC and resource allocation method according to the present invention can be used to effectively perform MAC and allocate resources according to a variety of data requests, it is possible to improve the reliability and QoS of a multi-hop wireless Ad hoc network and reduce power consumption.

Also, it is possible to efficiently use resources by simplifying initialization of communication, ensure the communication reliability of nodes constituting a network, enhance the performance of the network due to increase of communication opportunities, increase the reliability of important data and reduce the number of retransmission operations, using data types, priorities, and dynamic resource allocation in which multi-hop interference is considered, and disperses the multi-hop interference, thereby improving the performance of the network and reducing power consumption.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A recording medium storing a structure of a frame for performing Medium Access Control (MAC) and allocating resources in a multi-hop wireless Ad hoc network, the structure of a frame comprising:
an initialization field performing initialization of communication between nodes constituting the multi-hop wireless Ad hoc network; and
at least one slot comprising a high level link region for communication between Full Function Device (FFD) nodes existing within a one-hop distance from a reference FFD node, and a low level link region for communication between Reduced Function Device (RFD) nodes existing within a one-hop distance from the reference FFD node.

2. The recording medium of claim 1, wherein the initialization field comprising:
a first initialization region comprising a Request-To-Send (RTS) message and a Clear-To-Send (CTS) message that are received or transmitted from or to a first node trying to configure a communication channel; and
a second initialization region comprising a RTS message and a CTS message that are received or transmitted from or to a second node different from the first node and not subjected to initialization of communication.

3. The recording medium of claim 1, wherein the high level link region and the low level link region are varied, according to conditions comprising data types, data sizes, priorities, and multi-hop interference, which are generated between the nodes constituting the multi-hop wireless Ad hoc network.

4. The recording medium of claim 3, wherein, if data requiring urgent processing or data having a high priority is received, a slot having a good channel environment is allocated to the data.

5. The recording medium of claim 3, wherein a slot having a bad channel environment is allocated to a node having a high Signal to Inference and Noise Ratio (SINR) value in the multi-hop wireless Ad hoc network.

6. A method of performing Medium Access Control (MAC) and allocating resources in a multi-hop wireless Ad hoc network, the method comprising:
performing initialization of communication by receiving or transmitting a Request-To-Send (RTS) message and a Clear-To-Send (CTS) message from or to a node that is to be communicated with in the multi-hop wireless Ad hoc network;
constructing a frame comprising at least one slot comprising an initialization field for performing the initialization of communication, a high level link region for communication between Full Function Device (FFD) nodes in the multi-hop wireless Ad hoc network which exist within a one-hop distance in the multi-hop wireless Ad hoc network, and a low level link region for communication between Reduced Function Device (RFD) nodes in the multi-hop wireless Ad hoc network which exist within a one-hop distance from the reference FFD node;
allocating the resources to the frame on the basis of data types, priorities, and estimated interference values; and
performing communication between nodes in the multi-hop wireless Ad hoc network within the length of the frame, and then returning to the operation of performing initialization of communication.

7. The method of claim 6, wherein, in operation of performing initialization of communication, the initialization of communication is not performed in a next frame, if initialization of communication has been performed on the node and communication with the node is constantly performed.

8. The method of claim 7, wherein operation of performing initialization of communication comprises:
(a1) configuring a communication channel with nodes in the multi-hop wireless Ad hoc network;
(a2) performing initialization of communication on nodes in the multi-hop wireless Ad hoc network that do not configure the communication channel, using slots in another order which is different from an order of slots used for the nodes configuring the communication channel in operation configuring a communication channel with nodes in the multi-hop wireless Ad hoc network.

9. The method of claim 6, wherein the initialization field comprises:
a first initialization region comprising a Request-To-Send (RTS) message and a Clear-To-Send (CTS) message that are received or transmitted from or to a first node in the multi-hop wireless Ad hoc network trying to configure a communication channel; and
a second initialization region comprising a RTS message and a CTS message that are received or transmitted from or to a second node in the multi-hop wireless Ad hoc network different from the first node and not subjected to initialization of communication.

10. The method of claim 6, wherein operation of allocating the resources to the frame comprises allocating a slot having a good channel environment to data requiring urgent processing or data having a high priority.

11. The method of claim 6, wherein operation of allocating the resources to the frame comprises allocating a slot having a bad channel environment to a node having a high Signal to Interference and Noise Ratio (SINR) value in the multi-hop wireless Ad hoc network.

12. A computer-readable recording medium having embodied thereon a program for executing a method of performing Medium Access Control (MAC) and allocating resources in a multi-hop wireless Ad Hoc network, the method comprising:
performing communication initialization by receiving or transmitting a Request-To-Send (RTS) message and a Clear-To-Send (CTS) message from or to a node that is to be communicated with in the multi-hop wireless Ad hoc network;
constructing a frame comprising at least one slot comprising an initialization field for performing the communication initialization, a high level link region for communication between Full Function Device (FFD) nodes in the multi-hop wireless Ad hoc network which exist within a one-hop distance from a reference FFD node in the multi-hop wireless Ad hoc network, and a low level link region for communication between Reduced Function Device (RFD) nodes in the multi-hop wireless Ad hoc network which exist within one-hop distance from the reference FFD node.
allocating the resources to the frame on the basis of data types, priorities, and estimated interference values; and
performing communication between nodes within the frame, and then returning to the operation of performing initialization of communication.
